(19) United States
(12) Patent Application Publication
(10) Pub. No.: US 2003/0099111 A1
(43) Pub. Date: May 29, 2003

(54) Warning light device for attaching onto various objects

(76) Inventor: Jen Hsieh Shih, Chang Hua (TW)

Correspondence Address: Jen Hsieh Shih, P.O. Box 63-298, Taichung, 406, TW

(21) Appl. No.: 10/178,319

(22) Filed: Jun. 21, 2002

(30) Foreign Application Priority Data
Nov. 23, 2001 (TW) 90220340

(51) Int. Cl. B60Q 1/26

(52) U.S. Cl. 362/494; 362/505; 362/544

(57) ABSTRACT

A warning light device for attaching onto various objects includes a housing having a base plate which has a forwardly and inwardly extended outer peripheral flange, for forming a chamber in the base plate. A cover includes a rearwardly extended outer peripheral flange engaged onto and secured to the outer peripheral flange of the base plate by welding processes. A circuit board is received in the base plate, and a number of light devices are attached to the circuit board for generating warning lights. A metal plate may maintain the housing in a suitable curvature.

### BACKGROUND OF THE INVENTION

1. Field of the Invention

The present invention relates to a warning light device, and more particularly to a warning light device for attaching onto various objects, such as the curved portions of the vehicles.

2. Description of the Prior Art

Various kinds of typical warning light devices have been developed for attaching onto various objects, and for emitting the warning lights when required.

On example of the warning light devices is disclosed in U.S. Pat. No. 6,113,243 to Saul and comprises a number of light bulbs or light emitting diodes engaged in or embedded in a Teflon tube holder with such as the molding processes. The light bulbs or the light emitting diodes may be damaged inadvertently while molding the Teflon tube holder.

In addition, the Teflon material should be solidly filled and engaged in the tube holder, and includes a bad transparency that may seriously effect or decrease the outward emitting lights generated by the light bulbs or the light emitting diodes.

Furthermore, the light bulbs or the light emitting diodes may not be replaced by the other light bulbs or light emitting diodes when the light bulbs or the light emitting diodes are damaged or burned out, because the Teflon material may not be molded into the tube holder again after the new or replaced light members are engaged into the tube holder.

U.S. Pat. No. 5,193,895 to Naruke et al. discloses another typical warning light device and comprises a number of chip-type light emitting elements mounted in alignment on a circuit board, and engaged in a narrow, ribbon-like light body made of synthetic resin. An elastic resin lens is then formed by pouring a molding silicone material into an opening of the narrow, ribbon-like synthetic resin light body.

Similarly, the light emitting elements may also be damaged inadvertently while molding the ribbon-like tube body. In addition, the silicone molding material should also be solidly filled and engaged in the ribbon-like light body and includes a bad transparency that may seriously effect or decrease the outward emitting lights generated by the light bulbs or the light emitting diodes.

Furthermore, the light bulbs or the light emitting diodes may not be replaced by the other light bulbs or light emitting diodes when the light bulbs or the light emitting diodes are damaged or burned out, because the silicone molding material may not be molded into the ribbon-like body again after the new or replaced light members are engaged into the tube body.

The present invention has arisen to mitigate and/or obviate the afore-described disadvantages of the conventional warning light devices.

### SUMMARY OF THE INVENTION

The primary objective of the present invention is to provide a warning light device for attaching onto various objects, such as the curved portions of the vehicles.

The other objective of the present invention is to provide a warning light device having a hollow chamber of a housing that have not been solidly filled with an insert and that may be used for receiving and storing a number of light members.

In accordance with one aspect of the invention, there is provided a warning light device for attaching onto various objects, the warning light device comprising a housing including a base plate and a cover. The base plate includes an outer peripheral portion having a forwardly extended first outer peripheral flange, for forming a chamber in the first outer peripheral flange, the first outer peripheral flange includes a free front portion inclinedly and inwardly extended into the chamber of the base plate and includes an outer peripheral portion. The cover includes an outer peripheral portion having a second outer peripheral flange extended rearwardly therefrom and engaged with the outer peripheral portion of the first outer peripheral flange of the base plate, a circuit board is received in the chamber of the base plate, and a plurality of light devices are attached to the circuit board for generating lights through the cover. The first outer peripheral flange of the base plate and the second outer peripheral flange of the cover are preferably welded and secured together for safely and solidly receiving and retaining the light devices within the chamber of the base plate, and for forming an air-tight seal or a water-tight seal to the housing or to the base plate and the cover.

A metal plate may further be provided and engaged in the chamber of the base plate for maintaining the housing in a curvature corresponding to that of the curved portions of the objects.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view illustrating an attachment of one or more warning light devices in accordance with the present invention onto the curved portions of a vehicle;

FIG. 2 is a perspective view of the warning light device in accordance with the present invention;

FIG. 3 is an exploded view of the warning light device;

FIG. 4 is a cross sectional view taken along lines 4-4 of FIG. 2, illustrating the operation of the warning light device;

FIGS. 5, 6 are cross sectional views similar to FIG. 4, illustrating the arrangement and/or the formation of the warning light device; and

FIG. 7 is an exploded view illustrating the other arrangement of the warning light device.

### DETAILED DESCRIPTION OF THE PREFERRED EMBODIMENT

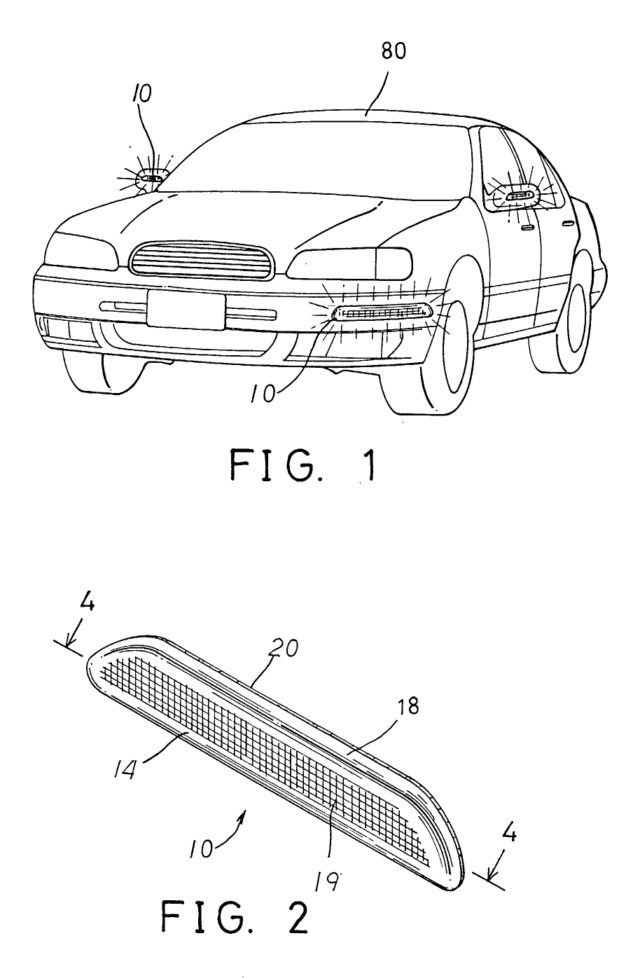

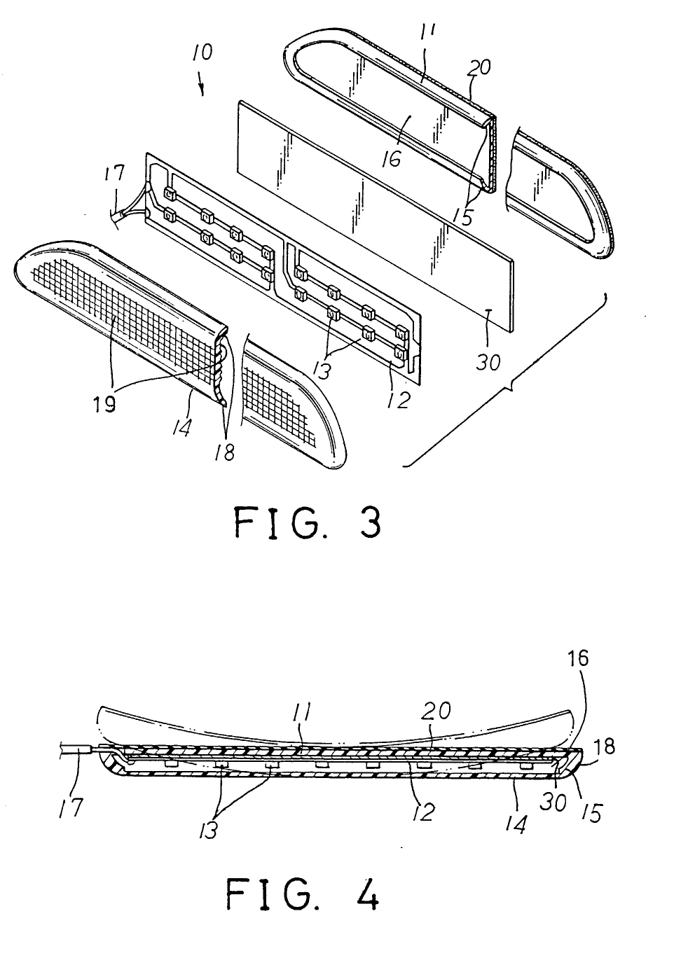

Referring to the drawings, and initially to FIGS. 1-4, a warning light device in accordance with the present invention comprises a housing 10 including a base plate 11 having a peripheral flange 15 extended forwardly or upwardly from the outer peripheral portion thereof for forming or defining a chamber 16 therein (FIGS. 3-7).

The peripheral flange 15 includes an upper or a front peripheral portion curved or bent or inclined inwardly the chamber 16 of the base plate 11.

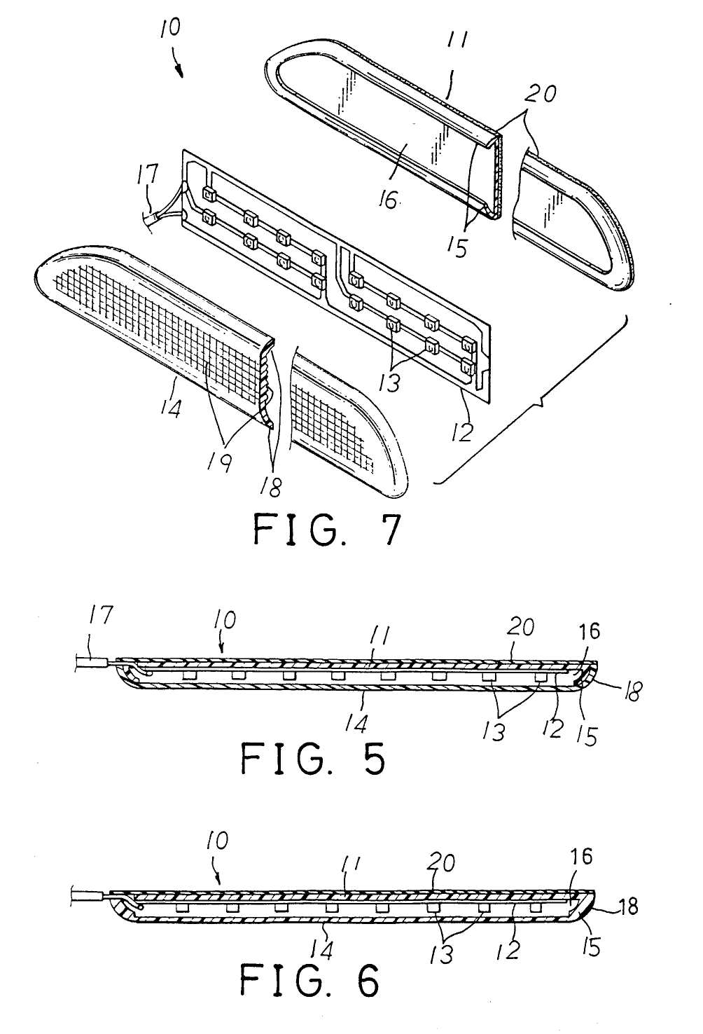

The housing 10 further includes a cover 14 having a peripheral flange 18 extended rearwardly or downwardly from the outer peripheral portion thereof for engaging with or onto the outer peripheral portion of the peripheral flange 15 of the base plate 11 (FIG. 5).

The peripheral flange 15 of the base plate 11 and the peripheral flange 18 of the cover 14 may then be secured together with such as a welding or ultrasonic welding process (FIGS. 4, 6), and for allowing the cover 14 to be solidly secured onto the base plate 11 in a water-tight and an air-tight seal, and for allowing the housing 10 to have the chamber 16 formed or defined therein.

The base plate 11 and the cover 14 of the housing 10 are made of flexible materials and thus may be slightly bent according to the curvature of the objects, such as of the vehicle portions, for allowing the housing 10 to be solidly attached onto the various curved portions of the vehicle without being easily disengaged from the vehicle.

A metal plate 30 may be optionally provided and may include a shape similar to or corresponding to that of the chamber 16 of the housing 10, for solidly engaging and retaining in the chamber 16 of the housing 10.

For example, the metal plate 30 may be bent to any suitable or selected curvature for maintaining the housing 10 in the curvature corresponding to that of the objects (FIG. 4). The housing 10 may also be arranged to have no metal plate 30 engaged therein (FIGS. 5-7).

The base plate 11 and the cover 14 of the housing 10 are preferably made of transparent or semitransparent materials, for allowing lights to be transmitted through the base plate 11 and the cover 14.

A circuit board 12 is engaged into or received in the chamber 16 of the base plate 11, and includes a number of light devices 13 attached thereto for generating lights, particularly the warning lights.

The light devices 13 may be arranged in one or more rows, and may be coupled to the electric power source of the vehicle with electric wires 17 which may be engaged through either or both peripheral flanges 15, 18 of the base plate 11 and the cover 14.

The circuit board 12 may be secured to the base plate 11 with such as the adhesive materials, or may be simply and freely disposed in the chamber 16 of the housing 10, or retained in the housing 10 by the peripheral flange 15. The light devices 13 may be safely received in and protected by the resilient or soft base plate 11 and the cover 14.

It is preferable that the cover 14 includes a knurled surface 19 formed in either or both the inner and the outer portions thereof, for such as the light diffusion purposes.

The housing 10 may include an adhesive material or an adhesive layer 20 attached to the bottom or the rear portion thereof, for securing onto the object, such as the curved portions of the vehicle 80.

The base plate 11 and the cover 14 have the peripheral flanges 15, 18 welded and secured together, for forming or defining the hollow chamber 16 in the housing 10, and for freely receiving the circuit board 12 and the light devices 13 therein.

When one or more of the light devices 13 have been damaged or burned out, the peripheral flanges 15, 18 may be cut to reach the light devices 13, or to disengage the light devices 13 from the housing 10, for allowing the light devices 13 to be replaced with the other light devices 13.

The peripheral flanges 15, 18 may then be secured together again by such as the welding processes, for solidly receiving and retaining the light devices 13 within the chamber 16 of the housing 10 again.

Accordingly, the warning light device may be attached onto various objects, such as the curved portions of the vehicles, and includes a housing having a hollow chamber that has no insert engaged therein and that may be used for receiving and storing a number of light members or devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A warning light device for attaching onto various objects, said warning light device comprising:
a housing including a base plate and a cover,
said base plate including an outer peripheral portion having a forwardly extended first outer peripheral flange, for forming a chamber in said first outer peripheral flange, said first outer peripheral flange including a free front portion inclinedly and inwardly extended into said chamber of said base plate and including an outer peripheral portion,
said cover including an outer peripheral portion having a second outer peripheral flange extended rearwardly therefrom and engaged with said outer peripheral portion of said first outer peripheral flange of said base plate,
a circuit board received in said chamber of said base plate, and
a plurality of light devices attached to said circuit board for generating lights through said cover,
said first outer peripheral flange of said base plate and said second outer peripheral flange of said cover being welded and secured together.

2. The warning light device according to claim 1 further comprising a metal plate engaged in said chamber of said base plate for maintaining said housing in a curvature.
